(19) United States
(12) Patent Application Publication
(10) Pub. No.: US 2025/0097126 A1
(43) Pub. Date: Mar. 20, 2025

(54) MAINTENANCE APPARATUS, NETWORK APPARATUS, INFORMATION VISUALIZATION SYSTEM, AND INFORMATION GENERATION METHOD

(71) Applicant: NEC Corporation, Tokyo (JP)

(72) Inventor: Satoki ABE, Tokyo (JP)

(73) Assignee: NEC Corporation, Tokyo (JP)

(21) Appl. No.: 18/756,067

(22) Filed: Jun. 27, 2024

(30) Foreign Application Priority Data
Sep. 14, 2023 (JP) 2023-149067

(51) Int. Cl. H04L 43/045

(52) U.S. Cl. CPC H04L 43/045

(57) ABSTRACT

An information visualization system includes: a network apparatus configured to generate traffic information in response to transmission/reception of a signal; an information collection apparatus configured to collect traffic information from the network apparatus; a visualization apparatus configured to acquire the traffic information from the information collection apparatus, generate a monitoring screen, based on the acquired traffic information, and display the generated monitoring screen; and a maintenance apparatus configured to extract, from a visualization item file in which the traffic information being used for generating the monitoring screen is described in a predetermined file format, a visualization target item being an item of traffic information to be visualized, and notify the network apparatus of the extracted visualization target item. The network apparatus initializes, with an initial value of 0, the traffic information of the visualization target item which has been notified from the maintenance apparatus.

### INCORPORATION BY REFERENCE

This application is based upon and claims the benefit of priority from Japanese patent application No. 2023-149067, filed on Sep. 14, 2023, the disclosure of which is incorporated herein in its entirety by reference.

### TECHNICAL FIELD

The present disclosure relates to a maintenance apparatus, a network apparatus, an information visualization system and method, an information generation method, and a program.

### BACKGROUND ART

As a related art, Japanese Unexamined Patent Application Publication No. 2021-069009 discloses a monitoring system. In the monitoring system described in Japanese Unexamined Patent Application Publication No. 2021-069009, a monitoring unit monitors a state of an object being monitored such as a server, a network switch, an OS, a hypervisor, middleware, or software. For example, an open source software (OSS) monitoring tool referred to as Prometheus is being used as the monitoring unit. The monitoring system generates event data, based on a message output from the monitoring unit, and stores the generated event data in an event storage unit. The monitoring system reads the event data from the event storage unit, outputs information associated with the read event data to a predetermined output unit, and thereby notifies a user of such information.

### SUMMARY

However, in Japanese Unexamined Patent Application Publication No. 2021-069009, when an object being monitored outputs information to the monitoring unit in a case where an event such as signal transmission/reception has occurred, the monitoring unit cannot acquire information from the object being monitored before the event occurs in the object being monitored. If visualization of information acquired by the monitoring unit is attempted by using a visualization apparatus such as Grafana, the visualization apparatus cannot display information that does not exist, and an error is output.

In view of the above-described issues, an example object of the present disclosure is to provide a maintenance apparatus, a network apparatus, an information visualization system, an information generation method, and a program that enable a visualization apparatus to visualize traffic information even before an event related to the traffic information occurs.

In a first example aspect, the present disclosure provides a network apparatus including: a traffic information generation unit configured to generate traffic information in response to transmission/reception of a signal; a visualization item acquisition unit configured to acquire a visualization target item being an item of traffic information to be visualized and being extracted from a visualization item file in which traffic information being used for generating a monitoring screen, that is generated based on the traffic information, is described in a predetermined file format; and an initialization unit configured to initialize, with an initial value of 0, traffic information of the acquired visualization target item.

In a second example aspect, the present disclosure provides a maintenance apparatus including: a visualization item extraction unit configured to extract a visualization target item being an item of traffic information to be visualized from a visualization item file in which traffic information being used for generating a monitoring screen, that is generated based on traffic information generated in a network apparatus in response to transmission/reception of a signal, is described in a predetermined file format; and a visualization item output unit configured to notify the network apparatus of the extracted visualization target item and cause the network apparatus to initialize, with an initial value of 0, traffic information of the visualization target item.

In a third example aspect, the present disclosure provides an information visualization system including: a network apparatus configured to generate traffic information in response to transmission/reception of a signal; an information collection apparatus configured to collect traffic information from the network apparatus; a visualization apparatus configured to acquire the traffic information from the information collection apparatus, generate a monitoring screen, based on the acquired traffic information, and display the generated monitoring screen; and a maintenance apparatus configured to extract a visualization target item being an item of traffic information to be visualized from a visualization item file in which traffic information being used for generating the monitoring screen is described in a predetermined file format, and notify the network apparatus of the extracted visualization target item, wherein the network apparatus initializes, with an initial value of 0, traffic information of the visualization target item notified from the maintenance apparatus.

In a fourth example aspect, the present disclosure provides an information generation method including: acquiring a visualization target item being an item of traffic information to be visualized, the visualization target item being extracted from a visualization item file in which traffic information being used for generating a monitoring screen, that is generated based on traffic information generated in response to transmission/reception of a signal, is described in a predetermined file format; initializing, with an initial value of 0, traffic information of the acquired visualization target item; and generating the traffic information, based on a signal transmitted/received in a network apparatus.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a block diagram illustrating a first information visualization system according to the present disclosure;

FIG. 2 is a block diagram illustrating a configuration example of a maintenance apparatus included in the first information visualization system;

FIG. 3 is a block diagram illustrating a configuration example of a network apparatus included in the first information visualization system;

FIG. 4 is a flowchart illustrating an operation procedure relating to the first information visualization system;

FIG. 5 is a block diagram illustrating a second information visualization system according to the present disclosure;

FIG. 6 is a block diagram illustrating a configuration example of a maintenance apparatus included in the second information visualization system; and

FIG. 7 is a flowchart illustrating an operation procedure relating to the second information visualization system.

FIG. 8 is a block diagram illustrating a configuration example of a computer apparatus; and

FIG. 9 is a block diagram illustrating a configuration example of a computer apparatus.

### EXAMPLE EMBODIMENT

Hereinafter, example embodiments of the present disclosure is described with reference to the drawings. Note that the following description and the drawings are omitted and simplified as appropriate for clarity of description. In the following drawings, the same elements and similar elements are denoted by the same reference signs, and redundant descriptions are omitted as necessary.

FIG. 1 illustrates a first information visualization system according to the present disclosure. A first example embodiment is described with reference to the information visualization system illustrated in FIG. 1. An information visualization system 100 includes a network apparatus 110, an information collection apparatus 120, a visualization apparatus 130, and a maintenance apparatus 140. The network apparatus 110 generates traffic information in response to transmission/reception of signals. The network apparatus 110 is, for example, a fifth generation core network (5GC) network function (NF).

The information collection apparatus 120 collects traffic information from the network apparatus 110. The function of the information collection apparatus 120 may be implemented by, for example, a monitoring tool such as Prometheus, which is OSS, being executed on a computer apparatus. The information collection apparatus 120 periodically collects traffic information from the network apparatus 110 at a predetermined time period, for example, one minute. The information collection apparatus 120 stores the collected traffic information in a storage apparatus (not illustrated).

The visualization apparatus 130 acquires traffic information from the information collection apparatus 120 and visualizes the acquired traffic information. For example, a user selects an item of traffic information to be visualized on a monitoring screen from a list of items of traffic information generated by the network apparatus 110. The user then sets, in the visualization apparatus 130, the selected item of traffic information as an item of traffic information to be visualized.

The visualization apparatus 130 queries the information collection apparatus 120 about the traffic information to be visualized. For example, the visualization apparatus 130 periodically queries the information collection apparatus 120 about the traffic information to be visualized, at a predetermined time period of, for example, three minutes. If the information collection apparatus 120 holds the queried traffic information, the information collection apparatus 120 transmits such piece of traffic information to the visualization apparatus 130 as a response to the query. If the information collection apparatus 120 does not hold the queried traffic information, the information collection apparatus 120 transmits notification of lack of information to the visualization apparatus 130 as a response to the query.

The visualization apparatus 130 visualizes the traffic information by, for example, displaying a graph, a character, a figure, and the like according to the acquired traffic information on a screen of a display apparatus. The function of the visualization apparatus 130 may be implemented by, for example, a visualization tool such as Grafana, which is OSS, being executed on a computer apparatus.

The maintenance apparatus 140 is an apparatus being used for maintenance and management of the network apparatus 110. In the present example embodiment, the maintenance apparatus 140 outputs an item of traffic information to be visualized in the visualization apparatus 130 to the network apparatus 110. The network apparatus 110 initializes, with an initial value of 0, the item of traffic information being input from the maintenance apparatus 140. The network apparatus 110 performs initialization at a time of activation, for example. After initialization, the network apparatus 110 generates traffic information in response to transmission/reception of signals.

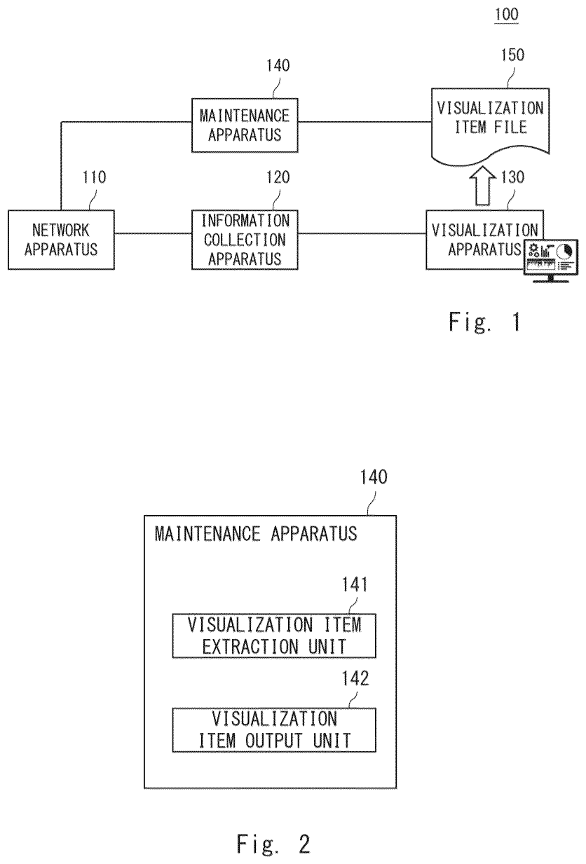

FIG. 2 illustrates a configuration example of the maintenance apparatus 140. The maintenance apparatus 140 includes a visualization item extraction unit 141 and a visualization item output unit 142. For example, a network element operation system (NE-OPS) apparatus may be used as the maintenance apparatus 140. The maintenance apparatus 140 may be physically configured as an apparatus including, for example, one or more processors and one or more memories. The function of each component in the maintenance apparatus 140 may be implemented by the one or more processors operating in accordance with instructions read from the one or more memories.

The visualization item extraction unit 141 acquires a visualization item file 150. The visualization item file 150 is a file in which an item of traffic information to be visualized in the visualization apparatus 130 is described. The visualization item file 150 is generated by, for example, exporting a Grafana dashboard, that is, a screen for visualizing traffic information. For example, in response to user manipulation, the visualization apparatus 130 outputs, as the visualization item file 150, a file in which items of traffic information to be visualized are described in JavaScript object notation (JSON) file format.

The visualization item extraction unit 141 analyzes the acquired visualization item file and extracts an item of traffic information visualized by the visualization apparatus 130. For example, it is assumed that the visualization item file 150 includes “sum (procedure_registration_type_mobility_attempt_per_slice_count_total)”. In such a case, the visualization item extraction unit 141 extracts “procedure_registration_type_mobility_attempt_per_slice_count_total” from the visualization item file 150. The visualization item output unit 142 outputs the item of traffic information extracted by the visualization item extraction unit 141 to the network apparatus 110.

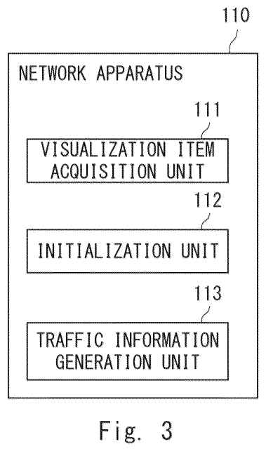

FIG. 3 illustrates a configuration example of the network apparatus 110. The network apparatus 110 includes a visualization item acquisition unit 111, an initialization unit 112, and a traffic information generation unit 113. The network apparatus 110 may be physically configured as an apparatus including, for example, one or more processors and one or more memories. The function of each component in the network apparatus 110 may be implemented by the one or more processors operating in accordance with instructions read from the one or more memories.

The visualization item acquisition unit 111 acquires an item of traffic information to be visualized being output from the maintenance apparatus 140. For example, the visualization item acquisition unit 111 queries the maintenance apparatus 140 about an item of traffic information to be visualized, at a time of activation of the network apparatus 110. The visualization item output unit 142 (see FIG. 2) of the maintenance apparatus 140 outputs the item of traffic information extracted by the visualization item extraction unit 141 to the network apparatus 110 as a response to the query.

The initialization unit 112 initializes, with an initial value of 0, the item of traffic information acquired by the visualization item acquisition unit 111. This initialization is performed only once, for example, at a time of activation of the network apparatus 110. The network apparatus 110 may hold a list of items of traffic information that has a possibility of being generated in the network apparatus 110. In such a case, the initialization unit 112 may initialize, with an initial value of 0, the item of traffic information acquired by the visualization item acquisition unit 111 among the traffic information that has a possibility of being generated in the network apparatus 110.

In a case where the item of traffic information acquired by the visualization item acquisition unit 111 is not included in the list of items of the traffic information that has a possibility of being generated in the network apparatus 110, the initialization unit 112 does not initialize such item of traffic information with an initial value of 0. In such a case, the initialization unit 112 outputs an error to the maintenance apparatus 140. For example, the network apparatus 110 notifies the maintenance apparatus 140 of the error through Alertmanager, which is an OSS alert management system. The maintenance apparatus 140 displays an error on the display screen and notifies a user such as a network administrator of the error. In such a case, the user can notice that an item of traffic information not generated in the network apparatus 110 is being set as the item of the traffic information to be visualized in the visualization apparatus 130, due to a configuration error or the like.

The traffic information generation unit 113 generates traffic information when an event related to a signal transmitted by the network apparatus 110 and a signal received by the network apparatus 110 occurs. For example, a case where the network apparatus 110 is a session management function (SMF) in 5GC and the SMF receives Nsmf_PDUSession_CreateSMContext Request from an access and mobility management function (AMF: subscriber) is assumed. In such a case, the traffic information generation unit 113 generates traffic information including a signal type, a label of a parameter and the like associated with the signal type, an argument, a domain name, and the like. When the item of the traffic information to be generated has been initialized with an initial value of 0, the traffic information generation unit 113 overwrites the initial value 0 with the generated traffic information.

In the present example embodiment, the information collection apparatus 120 (see FIG. 1) collects an initial value 0 from the network apparatus 110 for an item of traffic information with which no event has occurred. When an event occurs in the network apparatus 110 and therefore the traffic information generation unit 113 generates traffic information, the information collection apparatus 120 collects the traffic information generated by the traffic information generation unit 113. If some kind of problem occurs in the network apparatus 110 and the initialization of the traffic information is not performed, and further the generation of the traffic information is not performed, the information collection apparatus 120 cannot collect the traffic information.

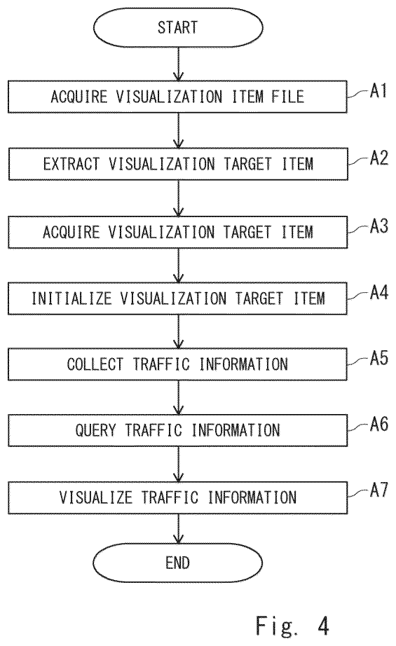

Next, an operation procedure is described. FIG. 4 illustrates an operation procedure relating to the information visualization system 100. The operation procedure relating to the information visualization system 100 includes an information generation method. The user gives the visualization apparatus 130 a calculation formula in which an item name of traffic information to be visualized in the monitoring screen, that is, an item name of the traffic information to be monitored, is input, and creates a dashboard being a visualization screen. The user operates the visualization apparatus 130 to export traffic information visualized on the monitoring screen from the menu of the dashboard to the visualization item file 150.

The visualization item extraction unit 141 of the maintenance apparatus 140 acquires the visualization item file 150 (step A1). The visualization item extraction unit 141 extracts an item of traffic information to be visualized from the acquired visualization item file 150 (step A2). For example, when the visualization item file 150 includes “sum (procedure_registration_type_mobility_attempt_per_slice_count_total)”, the visualization item extraction unit 141 extracts “procedure_registration_type_mobility_attempt_per_slice_count_total” as an item of the traffic information to be visualized.

The visualization item acquisition unit 111 (see FIG. 3) of the network apparatus 110 requests the item of traffic information to be visualized from the maintenance apparatus 140 at a time of activation. The visualization item acquisition unit 111 acquires the item of the traffic information to be visualized from the visualization item output unit 142 of the maintenance apparatus 140 (step A3). The initialization unit 112 initializes, with an initial value of 0, the item of the traffic information acquired in step A3 (step A4). For example, in step A4, the initialization unit 112 initializes “procedure_registration_type_mobility_attempt_per_slice_count_total” with an initialization value of 0. In step A4, the initialization unit 112 may initialize, with an initial value of 0, an item of the traffic information to be visualized among the items of the traffic information that has a possibility of being generated by the network apparatus 110. After the initialization, the traffic information generation unit 113 generates traffic information in response to occurrence of an event.

The information collection apparatus 120 periodically collects traffic information from the network apparatus 110 (step A5). In step A5, the information collection apparatus 120 acquires traffic information related to an event occurring in the network apparatus 110. The traffic information acquired by the information collection apparatus 120 may include traffic information that is not visualized by the visualization apparatus 130. In step A5, the information collection apparatus 120 acquires an initial value of 0 for the traffic information in which no event has occurred among the traffic information to be visualized.

The visualization apparatus 130 periodically queries the information collection apparatus 120 about data of the traffic information to be visualized (step A6). The information collection apparatus 120 transmits the traffic information that has been queried to the visualization apparatus 130 as a response to the query. The visualization apparatus 130 visualizes the traffic information received from the information collection apparatus 120 on the dashboard (step A7).

In a case where the visualization apparatus 130 queries traffic information the event of which has occurred, the information collection apparatus 120 transmits the traffic information related to the event that has occurred to the visualization apparatus 130 in step A6. In such a case, in step A7, the visualization apparatus 130 displays traffic information related to the event that has occurred on the dashboard. In a case where the visualization apparatus 130 queries traffic information in which no event has occurred, the information collection apparatus 120 transmits the initial value 0 to the visualization apparatus 130 in step A6. In such a case, the visualization apparatus 130 displays the initial value 0 on the dashboard in step A7.

In a case where the visualization apparatus 130 queries traffic information that has not been initialized and that has not been generated in the network apparatus 110, the information collection apparatus 120 transmits notification of lack of data or lack of value to the visualization apparatus 130 in step A6. In such a case, the visualization apparatus 130 does not display the traffic information on the dashboard in step A7. The visualization apparatus 130 may output an error when the traffic information is not displayed.

Hereinafter, a specific example is described. First, case 1-1 is described. Case 1-1 is a case in which traffic information is not generated in the network apparatus 110 for an item of traffic information to be visualized. In case 1-1, the visualization item file 150 includes “sum (procedure_registration_type_mobility_attempt_per_slice_count_total)”. The maintenance apparatus 140 extracts “procedure_registration_type_mobility_attempt_per_slice_count_total” from the visualization item file 150 as the visualization target item, and notifies the network apparatus 110 of the visualization target item.

The network apparatus 110 sets an initial value of 0 to “procedure_registration_type_mobility_attempt_per_slice_count_total”, and initializes the information of such item with an initial value of 0. The information collection apparatus 120 collects traffic information from the network apparatus 110 and holds the collected traffic information. For “procedure_registration_type_mobility_attempt_per_slice_count_total”, the information collection apparatus 120 acquires an initial value 0.

The visualization apparatus 130 transmits “query=sum(procedure_registration_type_mobility_attempt_per_slice_count_total)” to the information collection apparatus 120 to query about data of traffic information to be visualized. The information collection apparatus 120 transmits the value 0 held for “procedure_registration_type_mobility_attempt_per_slice_count_total” to the visualization apparatus 130 as a response to the query. The visualization apparatus 130 displays a value 0 in a monitoring screen for displaying the information relating to procedure_registration_type_mobility_attempt_per_slice_count_total.

Next, case 1-2 is described. Case 1-2 is a case in which traffic information is generated in the network apparatus 110 for an item of traffic information to be visualized. In the network apparatus 110, it is assumed that setting the value of “procedure_registration_type_mobility_attempt_per_slice_count_total” to an initial value 0 is similar to case 1-1.

The network apparatus 110 overwrites “procedure_registration_type_mobility_attempt_per_slice_count_total” with a value of 5, for example, after a signal transmission/reception event has occurred. The overwritten value may vary depending on the transmitted/received signal. For “procedure_registration_type_mobility_attempt_per_slice_count_total”, the information collection apparatus 120 acquires the value 5 from the network apparatus 110 and holds the acquired value 5.

The visualization apparatus 130 transmits “query=sum(procedure_registration_type_mobility_attempt_per_slice_count_total)” to the information collection apparatus 120 to query about data of traffic information to be visualized. The information collection apparatus 120 transmits the value 5 held for “procedure_registration_type_mobility_attempt_per_slice_count_total” to the visualization apparatus 130 as a response to the query. The visualization apparatus 130 displays the value 5 in a monitoring screen displaying information relating to procedure_registration_type_mobility_attempt_per_slice_count_total.

Next, case 1-3 is described. Case 1-3 is a case where there is an error in the item name of the traffic information in the visualization apparatus 130 due to a configuration error. The visualization item file 150 includes “sum (procedure_registration_type_mobility_attempt_per_slice_count)”. The maintenance apparatus 140 extracts “procedure_registration_type_mobility_attempt_per_slice_count” from the visualization item file 150 as the visualization target item, and notifies the network apparatus 110 of the visualization target item.

The network apparatus 110 determines whether the visualization target item is included in a list of items of traffic information that has a possibility of being generated. Herein, it is assumed that “procedure_registration_type_mobility_attempt_per_slice_count” is not included in the list of traffic information that has a possibility of being generated by the network apparatus 110. In such a case, the network apparatus 110 does not set the initial value 0 for such item. In addition, the network apparatus 110 may output an error and notify the network administrator or the like that the item “procedure_registration_type_mobility_attempt_per_slice_count” of the traffic information that is not generated is included in the visualization item file 150.

The information collection apparatus 120 collects traffic information from the network apparatus 110 and holds the collected traffic information. The information relating to “procedure_registration_type_mobility_attempt_per_slice_count” is not included in the traffic information collected by the information collection apparatus 120. The visualization apparatus 130 transmits “query=sum(procedure_registration_type_mobility_attempt_per_slice_count)” to the information collection apparatus 120 to query about data of traffic information to be visualized. The information collection apparatus 120 does not hold the traffic information of the queried item. Therefore, the information collection apparatus 120 transmits notification of lack of data to the visualization apparatus 130 as a response to the query. In such a case, the visualization apparatus 130 displays a display error on the monitoring screen.

Next, case 1-4 is described. Case 1-4 is a case in which some kind of problem occurs in the network apparatus 110 and the initialization of the visualization target item is not performed. In case 1-4, the visualization item file 150 includes “sum (procedure_registration_type_mobility_attempt_per_slice_count_total)”. The maintenance apparatus 140 extracts “procedure_registration_type_mobility_attempt_per_slice_count_total” from the visualization item file 150 as the visualization target item, and notifies the network apparatus 110 of the visualization target item.

The network apparatus 110 attempts to set an initial value of 0 to “procedure_registration_type_mobility_attempt_per_slice_count_total”. However, it is assumed that some kind of problem occurred in the network apparatus 110, and such initialization has not been performed. Further, it is assumed that the network apparatus 110 did not generate traffic information due to some kind of problem after the occurrence of the event, that is, after transmission/reception of a signal. In such cases, the information relating to “procedure_registration_type_mobility_attempt_per_slice_count_total” is not included in the traffic information collected by the information collection apparatus 120.

The visualization apparatus 130 transmits “query=sum(procedure_registration_type_mobility_attempt_per_slice_count_total)” to the information collection apparatus 120 to query about data of traffic information to be visualized. Since the information collection apparatus 120 does not hold the traffic information of the queried item, the information collection apparatus 120 transmits notification of lack of data to the visualization apparatus 130 as a response to the query. In such a case, the visualization apparatus 130 displays a display error on the monitoring screen.

In the present example embodiment, the maintenance apparatus 140 extracts, from the visualization item file 150, an item of traffic information to be visualized and used for generating the monitoring screen of the visualization apparatus 130. The maintenance apparatus 140 notifies the network apparatus 110 of the extracted item of traffic information to be visualized, that is, the visualization target item. The network apparatus 110 acquires the visualization target item from the maintenance apparatus 140, and initializes, with an initial value of 0, traffic information of the visualization target item.

In the present example embodiment, the network apparatus 110 initializes, with an initial value of 0, the traffic information of the visualization target item notified from the maintenance apparatus 140 instead of all the traffic information to be generated. In such a way, even when no event occurs in the network apparatus 110 and no traffic information is generated in the network apparatus 110, the information collection apparatus 120 is able to collect the initial value 0. When no event has occurred, the visualization apparatus 130 acquires traffic information having an initial value of 0. Therefore, the visualization apparatus 130 is able to visualize the traffic information even if no event has occurred.

Generally, an information collection apparatus 120, such as Prometheus, uses metric names and labels to distinguish between measured objects. The label has a pair of a label name and a label value. For example, the metrics for SMFs, which is one of the 5GC NFs, has labels such as sub network slice selection assist information (S-NSSAI), data network name (DNN), response code, and the like. By using such metrics, Prometheus can filter the labels and distinguish between the measured objects, e.g., “number of transmitted traffic of signal with response code=201 for slices with sst=1 and sd=000001”. Labels are generated according to received messages and configurations, and therefore have a large number of combinations. Assuming that all traffic information covering all combinations of labels is initialized to 0 in the network apparatus 110, the load is large from the viewpoint of the amount of data. In the present example embodiment, the traffic information to be initialized is limited to the traffic information to be visualized in the visualization apparatus 130. Therefore, the present example embodiment makes it possible to visualize traffic information in which no event has occurred, while suppressing an increase in load.

In addition, if the information collection apparatus 120 or the visualization apparatus 130 treats information which does not exist as a value 0, the visualization apparatus 130 is able to display such information with the value 0 even if no event has occurred. However, in such a case, the user cannot determine whether the visualization apparatus 130 is trying to refer to information that does not exist due to a configuration error, or there is no signal transmission/reception in the network apparatus 110.

In the present example embodiment, the network apparatus 110 is able to initialize, with an initial value of 0, an item of traffic information included in the list of items of traffic information that has a possibility of being generated by the network apparatus 110 among the visualization target items extracted from the visualization item file 150. In such a case, when an item name that is not generated in the network apparatus 110 is designated by the visualization apparatus 130, traffic information with such item name is not initialized with an initial value of 0 in the network apparatus 110. In other words, when the visualization apparatus 130 is trying to refer to information that does not exist due to a configuration error, such information is not initialized in the network apparatus 110. In such a case, the visualization apparatus 130 acquires notification of lack of information from the information collection apparatus 120. Therefore, in the present example embodiment, the user can determine whether the visualization apparatus 130 is trying to refer to information that does not exist due to a configuration error, or there is no signal transmission/reception in the network apparatus 110. In a case where the initialization is not performed in the network apparatus 110 due to some kind of problem, similarly, the visualization apparatus 130 acquires notification of lack of information from the information collection apparatus 120. Therefore, the user is able to detect the occurrence of a problem in the network apparatus 110.

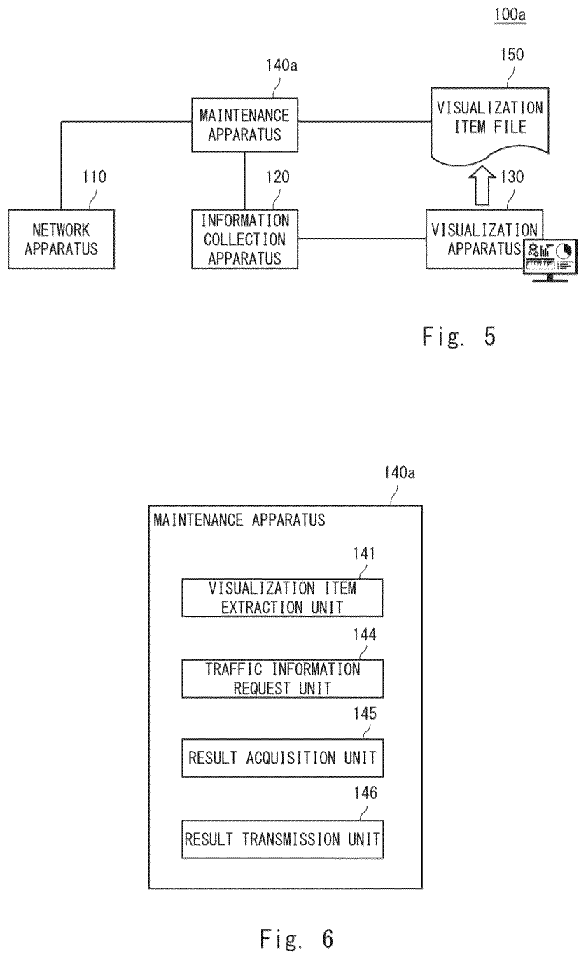

FIG. 5 illustrates a second information visualization system according to the present disclosure. A second example embodiment is described with reference to FIG. 5. An information visualization system 100a illustrated in FIG. 5 is different from the information visualization system 100 illustrated in FIG. 1 in that an information collection apparatus 120 acquires traffic information from a network apparatus 110 via a maintenance apparatus 140a. The configuration of the network apparatus 110 in the present example embodiment may have a configuration similar to that of the network apparatus 110 illustrated in FIG. 3 from which the initialization unit 112 is omitted.

FIG. 6 illustrates a configuration example of the maintenance apparatus 140a. The maintenance apparatus 140a includes a visualization item extraction unit 141, a traffic information request unit 144, a result acquisition unit 145, and a result transmission unit 146. The operation and the function of the visualization item extraction unit 141 may be similar to the function of the visualization item extraction unit 141 described in the first example embodiment.

In the present example embodiment, the information collection apparatus 120 transmits, to the maintenance apparatus 140a, a traffic information acquisition request requesting traffic information of the network apparatus 110. The traffic information request unit 144 transfers the traffic information acquisition request received from the information collection apparatus 120 to the network apparatus 110. The network apparatus 110 transmits the traffic information generated in the traffic information generation unit 113 (see FIG. 3) to the maintenance apparatus 140a. The result acquisition unit 145 acquires traffic information from the network apparatus 110 as a response to the transferred acquisition request. In the following description, the traffic information acquired by the result acquisition unit 145 is also referred to as a traffic information result.

The result transmission unit 146 determines whether the traffic information result acquired from the network apparatus 110 includes the item of the traffic information to be visualized extracted by the visualization item extraction unit 141. When determining that the item of the traffic information to be visualized is not included in the traffic information result, the result transmission unit 146 adds the item of the traffic information that is not included to the traffic information result with an initial value of 0. In such a case, the result transmission unit 146 transmits the traffic information result to which the item of the traffic information having the initial value of 0 has been added, to the information collection apparatus 120. When the traffic information result includes all items of the traffic information to be visualized, the result transmission unit 146 transmits the acquired traffic information result to the information collection apparatus 120 as it is.

For example, it is assumed that the visualization item file 150 includes items of traffic information “item A” and “item B”, and the visualization item extraction unit 141 extracts “item A” and “item B” as the items of the traffic information to be visualized. Further, it is assumed that the result acquisition unit 145 acquires traffic information of a total of 100 items from the network apparatus as the traffic information result. The result transmission unit 146 determines whether the traffic information including the traffic information of 100 items includes “item A” and “item B”. When determining that the traffic information result includes “item A” and “item B”, the result transmission unit 146 transmits the traffic information including the traffic information of 100 items to the information collection apparatus 120.

For example, when determining that the traffic information of “item A” is not included in the traffic information result, the result transmission unit 146 adds the traffic information of “item A” to the traffic information result. At this time, the result transmission unit 146 adds the traffic information of “item A” to the traffic information result with an initial value of 0. The result transmission unit 146 transmits, to the information collection apparatus 120, a traffic information result including traffic information of a total of 101 items, for example, to which traffic information of “item A” with an initial value of 0 is added.

In the present example embodiment, the maintenance apparatus 140a may hold a list of items of traffic information that has a possibility of being generated in the network apparatus 110. In such a case, the visualization item extraction unit 141 may determine whether the item of traffic information extracted from the visualization item file 150 is included in the traffic information that has a possibility of being generated in the network apparatus 110. The visualization item extraction unit 141 may output an error when the extracted item of traffic information is not included in the traffic information that has a possibility of being generated in the network apparatus 110. The maintenance apparatus 140a displays an error on the display screen and notifies a user such as a network administrator of the error. In such a case, the user can notice that an item of traffic information not generated in the network apparatus 110 is set as an item of the traffic information to be visualized in the visualization apparatus 130 due to a configuration error or the like.

In addition, when the extracted item of the traffic information is not included in the traffic information that has a possibility of being generated in the network apparatus 110, the visualization item extraction unit 141 may exclude such item of the traffic information from the extracted items of the traffic information. For example, in a case where the visualization item file 150 includes the items of traffic information “item A” and “item B”, it is assumed that the network apparatus 110 does not generate the traffic information of “item A”. In such a case, the visualization item extraction unit 141 extracts “item B” as an item of traffic information to be visualized. The result transmission unit 146 determines whether the traffic information of “item B” is included in the traffic information result. In such a case, the result transmission unit 146 does not add the traffic information of “item A”, which is not generated in the network apparatus 110, to the traffic information result.

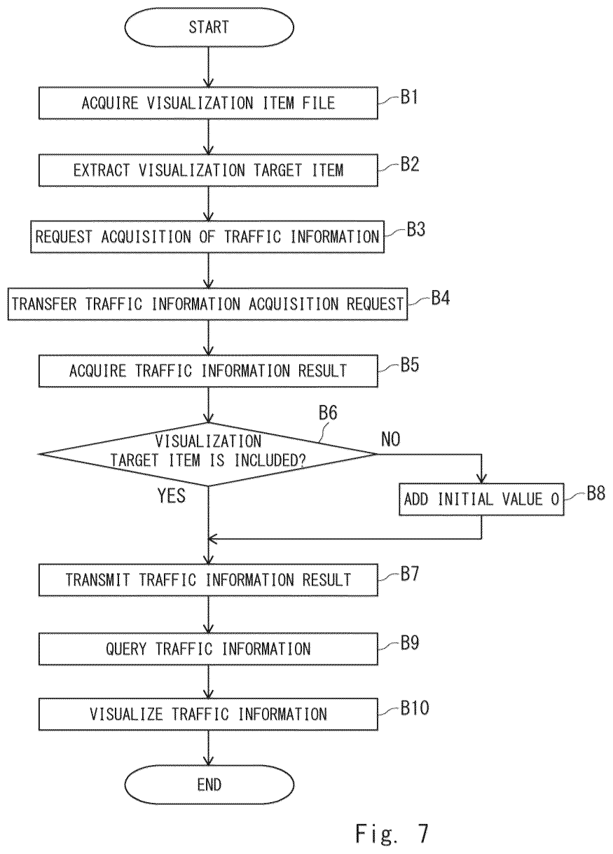

Next, an operation procedure is described. FIG. 7 illustrates an operation procedure relating to the information visualization system 100a. The operation procedure relating to the information visualization system 100a includes an information generation method. The user gives the visualization apparatus 130 a calculation formula in which the item name of the traffic information to be visualized on the monitoring screen, that is, the item name of the traffic information to be monitored is input, to the visualization apparatus 130, and generates a dashboard being a visualization screen. The user operates the visualization apparatus 130 to export traffic information visualized on the monitoring screen from the menu of the dashboard to the visualization item file 150.

The visualization item extraction unit 141 of the maintenance apparatus 140a acquires the visualization item file 150 (step B1). The visualization item extraction unit 141 extracts an item of traffic information to be visualized from the acquired visualization item file 150 (step B2). The operations of steps B1 and B2 may be similar to the operations of steps A1 and A2 in FIG. 4. In step B2, the visualization item extraction unit 141 may extract, as an item of traffic information to be visualized, an item included in an item of traffic information that has a possibility of being generated in the network apparatus 110 among items included in the visualization item file 150. The visualization item extraction unit 141 stores the extracted item of traffic information of the visualization target in a storage apparatus (not illustrated).

The information collection apparatus 120 periodically requests the maintenance apparatus 140a to acquire the traffic information (step B3). The traffic information request unit 144 of the maintenance apparatus 140a transfers the traffic information acquisition request to the network apparatus 110 (step B4). The result acquisition unit 145 acquires the traffic information result from the network apparatus 110 (step B5). In step B5, the result acquisition unit 145 acquires traffic information related to an event occurring in the network apparatus 110.

The result transmission unit 146 determines whether the traffic information result acquired in step B5 includes the item of the traffic information to be visualized extracted in step B2 (step B6). If it is determined in step B6 that the traffic information result includes all items of the traffic information to be visualized, the result transmission unit 146 transmits the traffic information result acquired in step B5 to the information collection apparatus 120 (step B7).

When it is determined in step B6 that there is an item of the traffic information to be visualized that is not included in the traffic information result, the result transmission unit 146 adds an initial value of 0 to the traffic information result for the item (step B8). Thereafter, the result transmission unit 146 proceeds to step B7, and transmits the traffic information result, to which the traffic information having the initial value of 0 is added, to the information collection apparatus 120.

The visualization apparatus 130 periodically queries the information collection apparatus 120 about the data of the traffic information to be visualized (step B9). The information collection apparatus 120 transmits the traffic information that has been queried to the visualization apparatus 130 as a response to the query. The visualization apparatus 130 visualizes the traffic information received from the information collection apparatus 120 in the dashboard (step B10). The operations of steps B9 and B10 may be similar to the operations of steps A6 and A7 in FIG. 4.

When the visualization apparatus 130 queries about traffic information of which an event has occurred, the information collection apparatus 120 transmits the traffic information related to the event that has occurred to the visualization apparatus 130 in step B9. In such a case, the visualization apparatus 130 displays the traffic information related to the event that has occurred on the dashboard in step B9. When the visualization apparatus 130 queries about the traffic information in which no event has occurred, the information collection apparatus 120 transmits the initial value 0 added in the maintenance apparatus 140a to the visualization apparatus 130 in step B9. In such a case, the visualization apparatus 130 displays the initial value 0 on the dashboard in step B10.

When the visualization apparatus 130 queries about the traffic information that is not generated in the network apparatus 110, the information collection apparatus 120 transmits notification of lack of data or lack of value to the visualization apparatus 130 in step B9. In such a case, the visualization apparatus 130 does not display the traffic information on the dashboard in step B10. The visualization apparatus 130 may output an error when the traffic information is not displayed.

Hereinafter, a specific example is described. First, case 2-1 is described. Case 2-1 is a case in which traffic information is not generated, in the network apparatus 110, for an item of traffic information to be visualized. In case 2-1, the visualization item file 150 includes “sum (procedure_registration_type_mobility_attempt_per_slice_count_total)”. The maintenance apparatus 140a extracts “procedure_registration_type_mobility_attempt_per_slice_count_total” as a visualization target item from the visualization item file 150.

The information collection apparatus 120 requests traffic information to the maintenance apparatus 140a. The maintenance apparatus 140a requests traffic information to the network apparatus 110, and acquires a traffic information result from the network apparatus 110. The maintenance apparatus 140a determines whether “procedure_registration_type_mobility_attempt_per_slice_count_total” is included in the traffic information result. Herein, it is assumed that the “procedure_registration_type_mobility_attempt_per_slice_count total” information is not included in the traffic information. In such a case, the information collection apparatus 120 adds “procedure_registration_type_mobility_attempt_per_slice_count_total” to the traffic information result with an initial value of 0. The information collection apparatus 120 acquires the traffic information result acquired by adding the information relating to “procedure_registration_type_mobility_attempt_per_slice_count_total” from the maintenance apparatus 140a.

The visualization apparatus 130 transmits “query=sum(procedure_registration_type_mobility_attempt_per_slice_count_total)” to the information collection apparatus 120 to query about data of traffic information to be visualized. The information collection apparatus 120 transmits the value 0 held for “procedure_registration_type_mobility_attempt_per_slice_count_total” to the visualization apparatus 130 in response to the query. The visualization apparatus 130 displays a value 0 in a monitoring screen for displaying the information of the procedure_registration_type_mobility_attempt_per_slice_count_total.

Next, case 2-2 is described. Case 2-2 is a case in which traffic information is generated, in the network apparatus 110, for an item of traffic information to be visualized. In the network apparatus 110, it is assumed that the point at which “procedure_registration_type_mobility_attempt_per_slice_count_total” is extracted as the visualization target item is similar to case 2-1 described above.

After the signal transmission/reception event has occurred, the network apparatus 110 generates the traffic information relating to “procedure_registration_type_mobility_attempt_per_slice_count_total”. The value is, for example, 5. The information collection apparatus 120 requests traffic information to the maintenance apparatus 140a. The maintenance apparatus 140a requests traffic information to the network apparatus 110 and acquires the traffic information result from the network apparatus 110 as a response to the request. The traffic information result includes the information relating to “procedure_registration_type_mobility_attempt_per_slice_count_total”, the value of which is 5. In such a case, the maintenance apparatus 140a transmits the traffic information result acquired from the network apparatus 110 to the information collection apparatus 120. For “procedure_registration_type_mobility_attempt_per_slice_count_total”, the information collection apparatus 120 acquires the value 5 from the maintenance apparatus 140a and holds the acquired value 5.

The visualization apparatus 130 transmits “query=sum(procedure_registration_type_mobility_attempt_per_slice_count_total)” to the information collection apparatus 120 to query about data of traffic information to be visualized. The information collection apparatus 120 transmits the value 5 held for “procedure_registration_type_mobility_attempt_per_slice_count_total” to the visualization apparatus 130 as a response to the query. The visualization apparatus 130 displays the value 5 in a monitoring screen for displaying the procedure_registration_type_mobility_attempt_per_slice_count_total information.

Next, case 2-3 is described. Case 2-3 is a case in which there is an error in the item name of the traffic information in the visualization apparatus 130 due to a configuration error. The visualization item file 150 includes “sum (procedure_registration_type_mobility_attempt_per_slice_count)”. The maintenance apparatus 140a extracts “procedure_registration_type_mobility_attempt_per_slice_count” as a visualization target item from the visualization item file 150.

The maintenance apparatus 140a determines whether the extracted visualization target item is included in a list of items of traffic information that has a possibility of being generated in the network apparatus 110. If “procedure_registration_type_mobility_attempt_per_slice_count” is not included in the list of traffic-information that has a possibility of being generated by the network apparatus 110, the maintenance apparatus 140a outputs an error. In addition, the maintenance apparatus 140a excludes “procedure_registration_type_mobility_attempt_per_slice_count” from the visualization target items extracted from the visualization item file 150. In such a case, the visualization target items do not include “procedure_registration_type_mobility_attempt_per_slice_count”.

The information collection apparatus 120 requests traffic information from the maintenance apparatus 140a. The maintenance apparatus 140a requests traffic information from the network apparatus 110 and acquires the traffic information result from the network apparatus 110 as a response to the request. The traffic information result does not include the information relating to “procedure_registration_type_mobility_attempt_per_slice_count”. However, in the maintenance apparatus 140a, “procedure_registration_type_mobility_attempt_per_slice_count” is excluded from the visualization target items. Therefore, the maintenance apparatus 140a transmits the traffic information result acquired from the network apparatus 110 to the information collection apparatus 120. In case 2-3, the traffic information result acquired by the information collection apparatus 120 does not include the information relating to “procedure_registration_type_mobility_attempt_per_slice_count”.

The visualization apparatus 130 transmits “query=sum(procedure_registration_type_mobility_attempt_per_slice_count)” to the information collection apparatus 120 to query about data of traffic information to be visualized. Since the information collection apparatus 120 does not hold the traffic information of the queried item, the information collection apparatus 120 transmits notification of lack of data to the visualization apparatus 130 as a response to the query. In such a case, the visualization apparatus 130 displays a display error on the monitoring screen. In case 2-3, it is possible to detect a configuration error in the visualization apparatus 130 in both the visualization apparatus 130 and the maintenance apparatus 140a.

Herein, in the present example embodiment, the maintenance apparatus 140a may monitor signals transmitted/received by the network apparatus 110 and generate a list of transmission/reception signals, that is, a list of signals transmitted/received by the network apparatus 110. In the maintenance apparatus 140a, the result transmission unit 146 may generate a list of transmission/reception signals. When there is an item of traffic information to be visualized that is not included in the traffic information result, the result transmission unit 146 may determine whether the network apparatus 110 has transmitted/received a signal related to the traffic information by using the list of transmission/reception signals. The result transmission unit 146 may generate a list of items of traffic information generated in association with the transmission/reception of signals, additionally or alternatively to the list of transmission/reception signals.

The result transmission unit 146 may determine whether the network apparatus 110 has transmitted/received a signal related to an item of traffic information to be visualized and not included in the traffic information result, by using the list of transmission/reception signals. The result transmission unit 146 adds, with an initial value of 0 to the traffic information result, an item of traffic information not included in the traffic information result and not including transmission/reception of a signal related to the list of transmission/reception signals. The result transmission unit 146 does not add, to the traffic information result, an item of traffic information that is not included in the traffic information result and includes transmission/reception of a signal related to the list of transmission/reception signals.

Specifically, as in cases 2-1 and 2-2, it is assumed that the visualization item file 150 includes “sum (procedure_registration_type_mobility_attempt_per_slice_count_total)”. The maintenance apparatus 140a extracts “procedure_registration_type_mobility_attempt_per_slice_count_total” as a visualization target item from the visualization item file 150. In addition, the maintenance apparatus 140a monitors signals transmitted/received by the network apparatus 110, and generates a list of transmission/reception signals.

The information collection apparatus 120 requests traffic information from the maintenance apparatus 140a. The maintenance apparatus 140a requests traffic information from the network apparatus 110 and acquires the traffic information result from the network apparatus 110 as a response to the request. The maintenance apparatus 140a determines whether “procedure_registration_type_mobility_attempt_per_slice_count_total” is included in the traffic information result. Herein, it is assumed that information relating to “procedure_registration_type_mobility_attempt_per_slice_count_total” is not included in the traffic information result.

When there is an item of the traffic information to be visualized that is not included in the traffic information result, the maintenance apparatus 140a determines whether a signal related to the item of the traffic information is included in the list of the transmission/reception signals. Herein, it is assumed that a signal related to “procedure_registration_type_mobility_attempt_per_slice_count_total” is included in the list of transmission/reception signals. In such a case, the maintenance apparatus 140a transmits the traffic information result as it is to the information collection apparatus 120 without adding the information relating to “procedure_registration_type_mobility_attempt_per_slice_count_total” to the traffic information result. The traffic information result acquired by the information collection apparatus 120 does not include information relating to “procedure_registration_type_mobility_attempt_per_slice_count_total”.

The visualization apparatus 130 transmits “query=sum(procedure_registration_type_mobility_attempt_per_slice_count_total)” to the information collection apparatus 120 to query about data of traffic information to be visualized. Since the information collection apparatus 120 does not hold the traffic information of the queried item, the information collection apparatus 120 transmits notification of lack of data to the visualization apparatus 130 as a response to the query. In such as case, the visualization apparatus 130 displays a display error on the monitoring screen.

It is assumed that a signal related to “procedure_registration_type_mobility_attempt_per_slice_count_total” is not included in the list of transmission/reception signals. In such a case, the maintenance apparatus 140a adds, with an initial value of 0, “procedure_registration_type_mobility_attempt_per_slice_count_total” to the traffic information result. The information collection apparatus 120 acquires the traffic information result to which information relating to “procedure_registration_type_mobility_attempt_per_slice_count_total” is added from the maintenance apparatus 140a. The visualization apparatus 130 acquires a value 0 for “procedure_registration_type_mobility_attempt_per_slice_count_total” from the information collection apparatus 120. In such a case, the visualization apparatus 130 displays a value 0 on the monitoring screen for displaying the information relating to procedure_registration_type_mobility_attempt_per_slice_count_total.

In the present example embodiment, the information collection apparatus 120 acquires traffic information from the network apparatus 110 via the maintenance apparatus 140a. The maintenance apparatus 140a determines whether the traffic information result acquired from the network apparatus 110 includes the information about the visualization target item extracted from the visualization item file 150. When the traffic information result does not include the information about the visualization target item, the maintenance apparatus 140a transmits, to the information collection apparatus 120, the traffic information result in which the initial value 0 is added as the information of such item. In this way, similarly to the first example embodiment, even when no event has occurred in the network apparatus 110 and no traffic information is generated in the network apparatus 110, the information collection apparatus 120 is able to collect the initial value 0. When no event has occurred, the visualization apparatus 130 acquires traffic information having an initial value of 0. Therefore, the visualization apparatus 130 is able to visualize the traffic information even when no event has occurred.

In the present example embodiment, the maintenance apparatus 140a is able to determine whether the visualization target item extracted from the visualization item file 150 is included in the list of items of traffic information that has a possibility of being generated by the network apparatus 110. The maintenance apparatus 140a is able to add an initial value of 0 to the traffic information result when the traffic information result does not include the information of the visualization target item and the visualization target item is included in the list of items of the traffic information that has a possibility of being generated by the network apparatus 110. In such a case, even when an item name not generated in the network apparatus 110 is designated from the visualization apparatus 130, traffic information of such item name is not added to the traffic information result in the maintenance apparatus 140a. Therefore, the present example embodiment also enables a user to determine whether the visualization apparatus 130 is trying to refer to information which does not exist, due to a configuration error, or there is no signal transmission/reception in the network apparatus 110.

Further, the maintenance apparatus 140a is able to monitor signals transmitted/received at the network apparatus 110 and determine whether a signal associated with an item of traffic information not included in the traffic information result has been transmitted/received at the network apparatus 110. The maintenance apparatus 140a is able to add an initial value of 0 to the traffic information result when the traffic information result does not include the information of the visualization target item and the network apparatus 110 has not transmitted/received a signal related to the visualization target item. When the network apparatus 110 has transmitted/received a signal related to the visualization target item not included in the traffic information result, the maintenance apparatus 140a does not add an initial value of 0 to the traffic information result. In such a case, the information collection apparatus 120 does not acquire an initial value of 0 for an item of traffic information, a signal of which is transmitted/received, and therefore originally generated in the network apparatus 110. In such a way, the user is able to determine whether traffic information has not been generated in the network apparatus 110 due to some kind of problem, or traffic information is not generated since no event has occurred.

Note that, in each of the above-described example embodiments, each apparatus in the information visualization system does not necessarily have to be configured as an independent, individual apparatus. In the information visualization system, some apparatuses may be implemented by using a physically identical apparatus. For example, in FIG. 1, the information collection apparatus 120 and the visualization apparatus 130 do not necessarily have to be configured as independent, individual apparatuses, and these apparatuses may be configured on a single apparatus. Further, in the information visualization system, each apparatus does not necessarily have to be configured as a single apparatus. In the information visualization system, some apparatuses may be configured with a plurality of physically separated apparatuses.

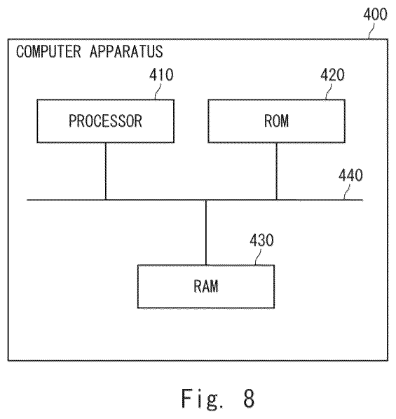

In the above-described example embodiments, at least a part of the functions of the network apparatus 110 may be implemented by a program executed on a computer. FIG. 8 illustrates a configuration example of a computer apparatus that may be used for the network apparatus 110. The computer apparatus 400 illustrated in FIG. 8 includes a processor 410 such as a central processing unit (CPU), a read only memory (ROM) 420, and a random access memory (RAM) 430. In the computer apparatus 400, the processor 410, the ROM 420, and the RAM 430 are connected to one another via a bus 440. The computer apparatus 400 may include other circuits, such as peripheral circuits, communication circuits, and interface circuits, not illustrated in FIG. 8.

The ROM 420 is a nonvolatile storage apparatus. For example, a semiconductor memory apparatus such as a flash memory having a relatively small capacity is used for the ROM 420. The ROM 420 stores a program to be executed by the processor 420.

The RAM 430 is a volatile storage apparatus. Various types of semiconductor memory devices such as a dynamic random access memory (DRAM) and a static random access memory (SRAM) are used for the RAM 430. The RAM 430 may be used as an internal buffer for temporarily storing data and the like.

The processor 410 loads the program stored in the ROM 420 into the RAM 430 and executes the loaded program. The CPU 410 executes the program, and thereby the function of each units of the network apparatus 110 can be implemented.

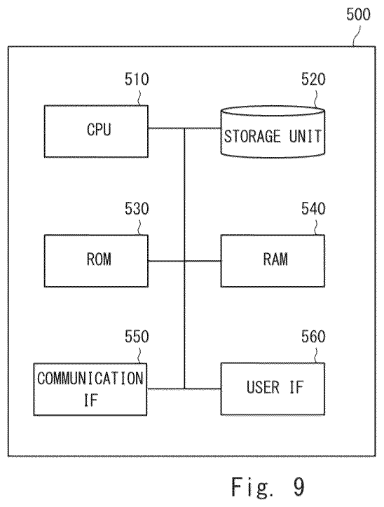

In the above-described example embodiments, at least a part of the functions of the information collection apparatus 120, the visualization apparatus 130, and the maintenance apparatus 140 may be implemented by a program executed on a computer. FIG. 9 illustrates a configuration example of a computer apparatus that may be used as the information collection apparatus 120, the visualization apparatus 130, or the maintenance apparatus 140. A computer apparatus 500 illustrated in FIG. 9 includes a processor 510 such as a CPU, a storage unit 520, a ROM 530, a RAM 540, a communication interface (IF) 550, and a user interface 560.

The communication interface 550 is an interface for connecting the computer apparatus 500 and a communication network via a wired communication means, a wireless communication means, or the like. The user interface 560 includes a display unit such as a display. The user interface 560 includes an input unit such as a keyboard, a mouse, or a touch panel.

The storage unit 520 is an auxiliary storage apparatus capable of holding various types of data. The storage unit 520 is not necessarily a part of the computer apparatus 500, and may be an external storage apparatus or a cloud storage connected to the computer apparatus 500 via a network.

The ROM 530 is a nonvolatile storage apparatus. For example, a semiconductor memory apparatus such as a flash memory having a relatively small capacity is used for the ROM 530. The program executed by the CPU 510 may be stored in the storage unit 520 or the ROM 530. The storage unit 520 or the ROM 530 stores programs for implementing the functions of the units of the information collection apparatus 120, the visualization apparatus 130, and the maintenance apparatus 140.

The RAM 540 is a volatile storage apparatus. Various semiconductor memory devices such as DRAM and SRAM are used for the RAM 540. The RAM 540 may be used as an internal buffer for temporarily storing data and the like. The CPU 510 loads a program stored in the storage unit 520 or the ROM 530 into the RAM 540, and executes the loaded program. The CPU 510 executes the program, and thereby the function of each unit of the information collection apparatus 120, the visualization apparatus 130, or the maintenance apparatus 140 can be implemented. The CPU 510 may have an internal buffer capable of temporarily storing data and the like.

The program includes instructions (or software codes) that, when loaded into a computer, causes the computer to perform one or more of the functions described in the example embodiments. The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line. By way of example, and not limitation, transitory computer-readable media or communication media include electrical, optical, acoustic, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

An example advantage according to the maintenance apparatus, the network apparatus, the information visualization system, the information generation method, and the program according to the present disclosure is that, it is possible to enable a visualization apparatus to visualize traffic information even before an event related to the traffic information occurs.

The whole or part of the example embodiments disclosed above can be described as, but not limited to, the following supplementary notes.

### Supplementary Note 1

A network apparatus including:
a traffic information generation unit configured to generate traffic information in response to transmission/reception of a signal;
a visualization item acquisition unit configured to acquire a visualization target item being an item of traffic information to be visualized and being extracted from a visualization item file in which traffic information being used for generating a monitoring screen, that is generated based on the traffic information, is described in a predetermined file format; and
an initialization unit configured to initialize, with an initial value of 0, traffic information of the acquired visualization target item.

### Supplementary Note 2

The network apparatus according to supplementary note 1, wherein the initialization unit initializes, with an initial value of 0, traffic information relating to an item, among the visualization target items, included in items of traffic information generated by the traffic information generation unit.

### Supplementary Note 3

The network apparatus according to supplementary note 2, wherein the initialization unit outputs an error when the visualization target items include an item not included in items of traffic information generated by the traffic information generation unit.

### Supplementary Note 4

The network apparatus according to any one of supplementary notes 1 to 3, wherein the visualization item acquisition unit acquires the visualization target item at a time of activation of the network apparatus.

### Supplementary Note 5

A maintenance apparatus including:
a visualization item extraction unit configured to extract a visualization target item being an item of traffic information to be visualized from a visualization item file in which traffic information being used for generating a monitoring screen, that is generated based on traffic information generated in a network apparatus in response to transmission/reception of a signal, is described in a predetermined file format; and
a visualization item output unit configured to notify the network apparatus of the extracted visualization target item and cause the network apparatus to initialize, with an initial value of 0, traffic information of the visualization target item.

### Supplementary Note 6

The maintenance apparatus according to supplementary note 5, wherein the visualization item extraction unit notifies the network apparatus of the extracted visualization target item at a time of activation of the network apparatus.

### Supplementary Note 7

An information visualization system including:
a network apparatus configured to generate traffic information in response to transmission/reception of a signal;
an information collection apparatus configured to collect traffic information from the network apparatus;
a visualization apparatus configured to acquire the traffic information from the information collection apparatus, generate a monitoring screen, based on the acquired traffic information, and display the generated monitoring screen; and
a maintenance apparatus configured to extract a visualization target item being an item of traffic information to be visualized from a visualization item file in which traffic information being used for generating the monitoring screen is described in a predetermined file format, and notify the network apparatus of the extracted visualization target item,
wherein the network apparatus initializes, with an initial value of 0, traffic information of the visualization target item notified from the maintenance apparatus.

### Supplementary Note 8

The information visualization system according to supplementary note 7, wherein the network apparatus initializes, with an initial value of 0, traffic information of an item, among the visualization target items, included in items of traffic information generated by the network apparatus.

### Supplementary Note 9

The information visualization system according to supplementary note 8, wherein the network apparatus outputs an error when the visualization target items include an item not included in items of traffic information generated by the network apparatus.

### Supplementary Note 10

The information visualization system according to any one of supplementary notes 7 to 9, wherein the maintenance apparatus notifies the network apparatus of the extracted visualization target item at a time of activation of the network apparatus.

### Supplementary Note 11

An information generation method including:
acquiring a visualization target item being an item of traffic information to be visualized, the visualization target item being extracted from a visualization item file in which traffic information being used for generating a monitoring screen, that is generated based on traffic information generated in response to transmission/reception of a signal, is described in a predetermined file format;
initializing, with an initial value of 0, traffic information of the acquired visualization target item; and
generating the traffic information, based on a signal transmitted/received in a network apparatus.

### Supplementary Note 12

A program for causing a computer to execute processing including:
acquiring a visualization target item being an item of traffic information to be visualized, the visualization target item being extracted from a visualization item file in which traffic information being used for generating a monitoring screen, that is generated based on traffic information generated in response to transmission/reception of a signal, is described in a predetermined file format;
initializing, with an initial value of 0, traffic information of the acquired visualization target item; and
generating the traffic information, based on a signal transmitted/received in a network apparatus.

### Supplementary Note 13

A maintenance apparatus including:
a visualization item extraction unit configured to extract a visualization target item being an item of traffic information to be visualized from a visualization item file in which traffic information being used for generating a monitoring screen, that is generated in a visualization apparatus, based on traffic information generated in a network apparatus in response to transmission/reception of a signal, is described in a predetermined file format;
a traffic information request unit configured to request the network apparatus for transmission of the traffic information;
a result acquisition unit configured to acquire, from the network apparatus, a traffic information result including traffic information generated in the network apparatus; and
a result transmission unit configured to determine whether information of the extracted visualization target item is included in the traffic information result, and when it is determined that traffic information of the visualization target item is not included in the traffic information result, add information relating to an item, which is among the visualization target items, of traffic information not included in the traffic information result to the traffic information result with an initial value of 0, and cause the visualization apparatus to acquire traffic information to which the initial value 0 is added.

### Supplementary Note 14

The maintenance apparatus according to supplementary note 13, wherein the visualization item extraction unit extracts, as the visualization target item, an item included in items of traffic information generated in the network apparatus from among items of traffic information described in the visualization item file.

### Supplementary Note 15

The maintenance apparatus according to supplementary note 14, wherein the visualization item extraction unit outputs an error when the visualization target items include an item not included in the items of traffic information generated by the network apparatus.

### Supplementary Note 16

The maintenance apparatus according to any one of supplementary notes 13 to 15, wherein the result transmission unit is further configured to: monitor a signal transmitted/received in the network apparatus; when it is determined that the traffic information of the visualization target item is not included in the traffic information result, determine whether the network apparatus has transmitted/received a signal related to traffic information of the visualization target item not included in the traffic information result; and when it is determined that the network apparatus had not transmitted/received a signal related to traffic information of the visualization target item not included in the traffic information result, add, with an initial value of 0, information relating to an item of traffic information not included in the traffic information result to the traffic information result.

### Supplementary Note 17

The maintenance apparatus according to supplementary note 16, wherein when it is determined that the network apparatus has transmitted/received a signal related to traffic information of the visualization target item not included in the traffic information result, the result transmission unit does not add, with an initial value of 0, information relating to an item of traffic information not included in the traffic information result to the traffic information result.

### Supplementary Note 18

An information visualization system including:
a network apparatus configured to generate traffic information in response to transmission/reception of a signal;
an information collection apparatus configured to collect traffic information from the network apparatus;
a visualization apparatus configured to acquire the traffic information from the information collection apparatus, generate a monitoring screen based on the acquired traffic information, and display the generated monitoring screen; and
the maintenance apparatus according to any one of supplementary notes 13 to 17.

### Supplementary Note 19

An information generation method including:
extracting a visualization target item being an item of traffic information to be visualized from a visualization item file in which traffic information being used for generating a monitoring screen, that is generated in a visualization apparatus, based on traffic information generated in a network apparatus in response to transmission/reception of a signal, is described in a predetermined file format;
requesting the network apparatus for transmission of the traffic information;
acquiring, from the network apparatus, a traffic information result including traffic information generated in the network apparatus;
determining whether information of the extracted visualization target item is included in the traffic information result; and
when it is determined that the traffic information of the visualization target item is not included in the traffic information result, adding information relating to an item, which is among the visualization target items, of traffic information not included in the traffic information result to the traffic information result with an initial value of 0, and causing the visualization apparatus to acquire traffic information to which the initial value 0 is added.

### Supplementary Note 20

A program for causing a computer to execute processing including:
extracting a visualization target item being an item of traffic information to be visualized from a visualization item file in which traffic information being used for generating a monitoring screen, that is generated in a visualization apparatus, based on traffic information generated in a network apparatus in response to transmission/reception of a signal, is described in a predetermined file format;
requesting the network apparatus for transmission of the traffic information;
acquiring, from the network apparatus, a traffic information result including traffic information generated in the network apparatus;
determining whether information of the extracted visualization target item is included in the traffic information result; and
when it is determined that the traffic information of the extracted visualization target item is not included in the traffic information result, adding information relating to an item, which is among the visualization target items, of traffic information not included in the traffic information result to the traffic information result with an initial value of 0, and causing the visualization apparatus to acquire traffic information to which the initial value of 0 is added.

What is claimed is:

1. A network apparatus comprising:
at least one first memory storing first instructions; and
at least one first processor configured to execute the first instructions to:
generate traffic information in response to transmission/reception of a signal;
acquire a visualization target item being an item of traffic information to be visualized and being extracted from a visualization item file in which traffic information being used for generating a monitoring screen, that is generated based on the traffic information, is described in a predetermined file format; and
initialize, with an initial value of 0, traffic information of the acquired visualization target item.

2. The network apparatus according to claim 1, wherein the at least one first processor is configured to execute the first instructions to initialize, with an initial value of 0, traffic information of an item, among the visualization target items, included in items of the traffic information generated by the network apparatus.

3. The network apparatus according to claim 2, wherein the at least one first processor is configured to execute the first instructions to output an error when the visualization target items include an item not included in items of the traffic information generated by the network apparatus.

4. The network apparatus according to claim 1, wherein the at least one first processor is configured to execute the first instructions to acquire the visualization target items at a time of activation of the network apparatus.

5. A maintenance apparatus comprising:
at least one second memory storing instructions; and
at least one second processor configured to execute the second instructions to:
extract a visualization target item being an item of traffic information to be visualized from a visualization item file in which traffic information being used for generating a monitoring screen, that is generated based on traffic information generated in a network apparatus in response to transmission/reception of a signal, is described in a predetermined file format; and
notify the network apparatus of the extracted visualization target item and cause the network apparatus to initialize, with an initial value of 0, traffic information of the visualization target item.

6. The maintenance apparatus according to claim 5, wherein the at least one second processor is configured to execute the second instructions to notify the network apparatus of the extracted visualization target item at a time of activation of the network apparatus.

7. An information visualization system comprising:
the network apparatus according to claim 1;
a maintenance apparatus comprising at least one second memory storing instructions; and at least one second processor configured to execute the second instructions to:
extract a visualization target item being an item of traffic information to be visualized from a visualization item file in which traffic information being used for generating a monitoring screen, that is generated based on traffic information generated in the network apparatus, is described in a predetermined file format; and
notify the network apparatus of the extracted visualization target item and cause the network apparatus to initialize, with an initial value of 0, traffic information of the visualization target item;
an information collection apparatus comprising at least one third memory storing third instructions and at least one third processor configured to execute the third instructions to collect traffic information from the network apparatus; and
a visualization apparatus comprising at least one fourth memory storing fourth instructions and at least one fourth processor configured to execute the fourth instructions to acquire the traffic information from the information collection apparatus, generate a monitoring screen, based on the acquired traffic information, and display the generated monitoring screen.

8. The information visualization system according to claim 7, wherein the at least one first processor is configured to execute the first instructions to initialize, with an initial value of 0, traffic information of an item, among the visualization target items, included in items of traffic information generated by the network apparatus.

9. The information visualization system according to claim 8, wherein the at least one first processor is configured to execute the first instructions to output an error when the visualization target items include an item not included in items of traffic information generated by the network apparatus.

10. The information visualization system according to claim 7, wherein the at least one second processor is configured to execute the second instructions to notify the network apparatus of the extracted visualization target item at a time of activation of the network apparatus.

11. An information generation method comprising:
acquiring a visualization target item being an item of traffic information to be visualized, the visualization target item being extracted from a visualization item file in which traffic information being used for generating a monitoring screen, that is generated based on traffic information generated in response to transmission/reception of a signal, is described in a predetermined file format;
initializing, with an initial value of 0, traffic information of the acquired visualization target item; and
generating the traffic information, based on a signal transmitted/received in a network apparatus.
